(19) United States
(12) Patent Application Publication
(10) Pub. No.: US 2026/0205557 A1
(43) Pub. Date: Jul. 16, 2026

(54) METHOD AND A SYSTEM FOR OPTIMIZING VIDEO FEED TO A LARGE PRE-TRAINED MODEL

(71) Applicant: ENDLESS TECHNOLOGIES LTD., Ramat Gan (IL)

(72) Inventor: Roi Avigdor GINAT, Los Gatos, CA (US)

(73) Assignee: ENDLESS TECHNOLOGIES LTD., Ramat Gan (IL)

(21) Appl. No.: 19/451,078

(22) Filed: Jan. 16, 2026

Related U.S. Application Data
(60) Provisional application No. 63/745,913, filed on Jan. 16, 2025.

(51) Int. Cl. H04N 7/01; G06V 20/40

(52) U.S. Cl. CPC H04N 7/0117; G06V 20/46

(57) ABSTRACT

A system and a method for optimizing the feed of streaming data to a large Pre-Trained Model (LPTM), the method may include actions such as: Obtaining a first streaming data from a high-resolution input device, the first streaming data is of high-resolution. Obtaining a second streaming data being at least one of sourced from a low-resolution input device, and a conversion of the first streaming data into low-resolution. Performing real-time analysis of at least one of the first streaming data and the second streaming data to determine loss of critical information in the second streaming data. And providing the second streaming data to a Large Pre-trained Model, at least part of the second streaming data augmented with interleaved data from the first streaming data, to avoid the loss of critical information.

### FIELD

The method and apparatus disclosed herein are related to the field of artificial intelligence (AI), and more particularly but not exclusively to optimizing interaction with a large pre-trained AI model (LPTM) such as a large language model (LLM), and more particularly but not exclusively to managing the feed of data having different levels of resolution (e.g., video or audio) to a large language model (LLM), or a similar large pre-trained AI model.

### BACKGROUND

Artificial intelligence (AI) and particularly large pre-trained models (LPTM) as well as large language models (LLM) are expensive, requiring large storage systems and much processing power. AI processing of video and audio is particularly expensive due to the large amount of data involved. Modern video and audio systems may provide high-resolution data that may further increase the amount of data to be processed, as well as the time for loading the data. There is therefore a need for a method and a system that may overcome these deficiencies.

### SUMMARY OF THE INVENTION

According to one exemplary embodiment, there is provided a computer-implemented method, a device, and a computer code for optimizing the feed of streaming data to a large Pre-Trained Model (LPTM), the method may include actions such as: Obtaining a first streaming data from a high-resolution input device, the first streaming data is of high-resolution. Obtaining a second streaming data being at least one of: sourced from a low-resolution input device, and a conversion of the first streaming data into low-resolution. Analyzing at least one of the first streaming data and the second streaming data to determine loss of critical information in the second streaming data. And providing the Large Pre-trained Model at least part of the second streaming data augmented with interleaved data from the first streaming data, to avoid the loss of the critical information.

According to another exemplary embodiment the method may additionally include converting the first streaming data into the second streaming data by reducing at least one of: spatial resolution, temporal resolution and color resolution.

Additionally, according to another exemplary embodiment, the method may be executed in real-time.

According to yet another exemplary embodiment the method may additionally include at least one of the actions of analyzing, by a machine-learning module operative to continuously analyze at least one of the first streaming data and the second streaming data, in real-time, based on predefined goals. Determining, in real-time, by a decision module operative to determine at least one optimal point to interleave data elements of the first streaming data in the second streaming data. And storing, locally, high-resolution data elements of the first streaming data.

According to still another exemplary embodiment the method may additionally include at least one of: evaluating, wherein the first streaming data is video, and the machine-learning module is operative to evaluate the video to identify frames of interest based on at least one of: motion detection, object recognition, scene change, camera motion, and change of field of view.

Further according to another exemplary embodiment the method may additionally include the actions of: Obtaining a first streaming data from a high-resolution input device, the first streaming data is of high-resolution. Obtaining a second streaming data being at least one of: sourced from a low-resolution input device, and a conversion of the first streaming data into low-resolution. Storing at least part of the first streaming data. Communicating at least part of the second streaming data to the LPTM. Receiving from the LPTM a request for at least part of the first streaming data, and communicating the requested at least part of the first streaming data to the LPTM.

Yet further according to another exemplary embodiment the first streaming data and the second streaming data may include data elements where each data element is identified by an identifier, and where the request for at least part of the first streaming data includes at least one identifier.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified block diagram of a feed optimization system;

FIG. 2 is a simplified block diagram of an ML analyzer module of the feed optimization system; and

FIG. 3 is a simplified block diagram of a decision module of the feed optimization system.

### DESCRIPTION OF THE EMBODIMENTS

The present embodiments comprise a method, one or more devices, and one or more software programs for optimizing the feeding of streaming data (e.g., audio, video, etc.) to an artificial intelligence (AI) system or software, and particularly (but not exclusively), to a Large Pre-Trained Model (LPTM) such as a Large Language Model (LLM).

The principles and operation of the system, a method, and/or a computer program for optimizing the feeding of multi-resolution data to an LPTM according to the several exemplary embodiments may be better understood with reference to the following drawings and accompanying description.

Before explaining at least one embodiment in detail, it is to be understood that the embodiments are not limited in their application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figures may use different scales and different scales can be used even within the same drawing, for example different scales for different views of the same object or different scales for the two adjacent objects.

The phrases ‘at least one’, ‘one or more’ and ‘and/or’, etc. are open-ended expressions that are both conjunctive and disjunctive in operation. For example, each of the expressions ‘at least one of A, B and C’, ‘at least one of A, B, or C’, ‘one or more of A, B, and C’, ‘one or more of A, B, or C’, and ‘A, B, and/or C' may mean ‘A alone, B alone, C alone, A and B together, A and C together, B and C together, or A, B and C together’.

The terms ‘a’ or ‘an entity’ may refer to one or more of that entity. As such, the terms ‘a’ (or ‘an’), ‘one or more' and ‘at least one' can be used interchangeably herein. It is also noted that the terms ‘comprising’, ‘including’, and ‘having’ can be used interchangeably.

Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment, and similar language throughout this specification may, but do not necessarily, all refer to the same embodiment.

The term ‘plurality’, as used herein, is defined as two or more than two. The term ‘another’, as used herein, is defined as at least a second or more. The term ‘coupled’, as used herein, is defined as connected, although not necessarily directly, and not necessarily mechanically.

In this document, the term ‘computing device’ may refer to any type of computing machine, including but not limited to, a computer, a portable computer, a laptop computer, a tablet computer, a mobile communication device, a network server, a cloud computer, etc., as well as any combination thereof. Such computing device or computing machine may include any type or combination of devices, including, but not limited to, a processor or a processing device, a memory device, a storage device, a user interface device, and/or a communication device.

The terms ‘execute’, ‘perform’, ‘compute’, ‘calculate’, ‘process’, etc. may refer to a processor of a computational device executing a software program code embodied on a non-transitory computer readable medium to achieve a result such as described after any of the terms ‘execute’, ‘perform’, ‘compute’, ‘calculate’, ‘process’, etc.

The term ‘client computing device’, or ‘client device’, ‘user device’ may refer to any type of computing device that is directly used, or operated, by a user. Such a device may include a user interface that may be used by a user directly, including means for user input and/or user output. Such a device may be communicatively coupled to another computing devices such as a network server via a communication network.

Means for user input may include a keyboard, a pointing device such as a mouse, a microphone, a camera, a touch-sensitive plate, or display, means for user gesture control, means for haptic user control, etc. Other means that may be considered as ‘user input’ may include various sensors such as inertial measuring units, heartbeat monitors, blood oxygen monitors, temperature monitors, etc.

It is appreciated that the term ‘user’ above may refer to a human user. However, the term ‘user’ may also refer to a machine, such as any type of computerized device and/or a software package. Particularly, the term ‘user’ may also refer to an AI system interacting with another AI system (LPTM).

Means for user output (namely, output to a user) may include a display, and/or any other means for providing visual information, a speaker, or earphone, and/or any other means for providing audible information, means for providing tactile and/or haptic information, etc. Means for ‘user output’ where the ‘user’ is a machine (system) may be any means of computer communication (e.g., a communication network).

The term ‘mobile communication device’ may refer to devices such as a tablet, a mobile telephone, a smartphone, etc.

The term ‘network server’ or ‘server’ may refer to any type of ‘computing device’ that is communicatively coupled to a communication network and may include a cloud computer, etc.

The term ‘communication network’ or ‘network’ may refer to any type or technology for digital communication including, but not limited to, the Internet, WAN, LAN, MAN, PSDN, etc. Any of the abovementioned technologies may be wired or wireless, for example, Wireless WAN such as WiMAX, WLAN (Wi-Fi), WPAN (Bluetooth), etc. Wireless networking technology may also include PLMN, and/or any type of cellular network. The term ‘communication network’ or ‘network’ may refer to any combination of communication technologies, and to any combination of physical networks. The term ‘communication network’ or ‘network’ may refer to any number of interconnected communication networks that may be operated by one or many network operators.

The term ‘communication’ may refer to the use of any communication network, or means of communication, by a user (person, human) to communicate content to another user.

Such communication may be direct like in a telephone call, or indirect (or store and forward), such as in messaging. Messaging can be half-duplex, for example, when the message is completed, stored, forwarded to the recipient, and then consumed by the recipient in whole before responding to the sender. Messaging can be full-duplex, for example, when the message may be forwarded to the recipient before it is completed and the recipient may respond to the sender before the message ends.

The terms ‘information’, ‘content’, and ‘medium’ (or ‘media’) may refer to any type of data generated by a human (e.g., using an input device), or by a machine (e.g., a server, LPTM, etc.).

The term ‘streaming content’, or ‘streaming data’, may refer to data provided as a stream of data elements being sent and/or received at a predetermined repetition such as video or audio, or their combination. The term ‘resolution’ may refer to the number of bits or bytes of each data element or each second of the streaming data. For example, video may be sent and/or received at the frequency of 30 frames per second (fps), where each frame may include the same number of pixels, and each pixel may include the same number of bytes. The number of fps here (temporal resolution) is arbitrary as well as the number of pixels in a frame (spatial resolution) and number of bits in a pixel (color resolution). ‘High-resolution’ may refer to a larger number of bits per data element or second of streaming data, and ‘low-resolution’ may refer to a smaller number of bits per data element or second of streaming data.

The term ‘feed’ or ‘data feed’ as well as ‘video feed’ and ‘audio feed’ may refer to a particular data stream provided as the input to a large language model (LLM) or large pre-trained model (LPTM)

The term ‘large language model’ (LLM) or large pre-trained model (LPTM) may refer to any type of pre-trained model that may analyze content and/or generate content.

The term ‘application’ may refer to a software program running on, or executed by, one or more processors of computing devices, and particularly by a mobile computing device such as a mobile telephone, a tablet, a smartphone, etc., as well as any other mobile or portable computing facility. The term ‘mobile application’ may refer to an application executed by a mobile computing device.

The term ‘interaction’ between pre-trained model and human may refer to a back-and-forth exchange of generated data between a human and a machine (e.g., LPTM). The term ‘iteration’ (when referring to interaction) may refer to a single interaction while the term “session’ may refer to a prolonged interaction comprising several iterations.

The terms ‘machine’, ‘model”, ‘pre-trained model’, and ‘LLM’ may be used interchangeably. It is appreciated that the system herein may be able to leverage previous interactions with a user (or users) to conduct a better current interaction with the user/s.

The term ‘system prompt’ may refer to any prompt that is fed to a large pre-trained model (LPTM) prior to (or with) a user prompt. The term ‘system prompt’ may also be known as a “model prompt”, and a “technical prompt”. All system prompts may be provided to the LPTM in every interaction with the LPTM.

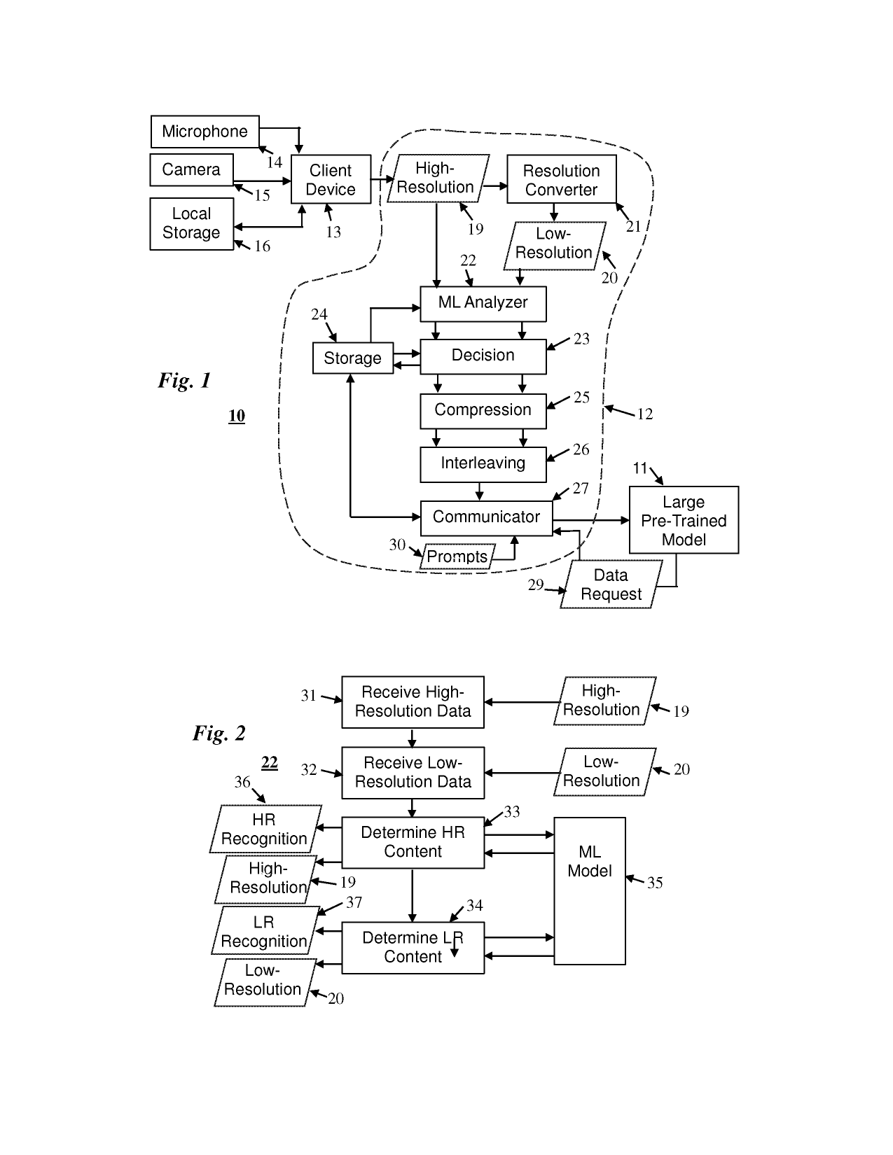

Reference is now made to FIG. 1, which is a simplified block diagram of a feed optimization system 10, according to one exemplary embodiment.

As seen in FIG. 1, the feed optimization system 10 may include a large language model (LLM) 11, communicatively coupled to a resolution optimization system 12, which is communicatively coupled to an input device 13 providing streaming content. It is noted that the terms ‘large language model 11’, ‘LLM 11’, and ‘LPTM 11’, are interchangeable and may refer to any pre-trained artificial intelligence (AI) system.

It is appreciated that input device 13 may be a client device such as a terminal, PC, smartphone, etc. or a (network) server, or both. Input device 13 may also include a microphone 14 to obtain streeaming audio. Alternatively or additionally, the input device 13 may also include a camera 15 to obtain photos and/or streeaming video. Alternatively or additionally, the input device 13 may also include a storage 16 to store high-resolution photos and/or high-resolution streeaming video, and/or high-resolution streamibng audio. Storage 16 may be a ’rolling storage’ in the sense that it may contain the last number of seconds, or frames, or bytes, etc. of the content data (e,g., pohtos, audio, and/or video).

It is appreciated that input device 13 may be implemented in part in a cloud computing environment and/or edge computing element. In this regard, It is appreciated that input device 13 may be a surveyance camera. It is appreciated that input device 13 may be communicatively coupled to decision module 23 may be notified. For example, ML analyzer module 22 may use such input to via any selected type of communication network.

It is appreciated that resolution optimization system 17 may be implemented in whole or in part in input device 13, for example a smart-phone. Alternatively, resolution optimization system 18 may be implemented in whole or in part in a cloud computing environment and/or edge computing element.

As shown in FIG. 1, resolution optimization system 12 may obtain from input device 13 high-resolution content 19, and convert it into low-resolution content 20 using resolution converter 21. It is appreciated that resolution converter 21 may be part of input device 13 and that resolution optimization system 12 may obtain from input device 13 both high-resolution content 19 and low-resolution content 20.

It is appreciated that resolution converter 21 may not be mandatory. For example, input device 13 may have two or more cameras where each camera has a different resolution. In such case resolution optimization system 12 may obtain from input device 13 high-resolution content 19 from a first camera and low-resolution content 20 from a seond camera. It is appreciated that such two cameras may differ by their field of view. For example, the ‘high-resolution’ camera may be a wide-angle camera, and the ‘low-resolution’ camera may be a narrow-angle camera, or vice-versa. In some situations where two cameras are available the system may still use a resolution converter for reasons such as limited bandwidth, processing power, energy conservation, etc.

For example, if the ratio between the high-resolution content 19 and the low-resolution content 20 (which may be measured for example in bits-per-second) is high enough to accommodate a mid-low resolution (one or more). Hence, if the quality of the lowest resolutionn data is deemed insufficient, the resolution converter 21 may convert high-resolution content 19 into a mid-resolution content.

It is appreciated that the goal of resolution optimization system 12 may be to reduce the load on LPTM 11 by providing the LPTM 11 the minimal amount of data that may provide the required result (in terms of LPTM 11 response). This goal may reduce bandwidth load, and/or reduce the data loading time, and/or reduce the data processing load, and/or reduce the response time of the LPTM 11, and/or reduce the cost of using LPTM 11, etc.

As shown in FIG. 1, resolution optimization system 12 may include an analyzer module 22, which may be a machine learning analyzer module. Analyzer 22 may reciev any or both of high-resolution content 19, and low-resolution content 20 to analyze situations in which the conversion into low-resolution may cause a loss of information that may be critical for LPTM 11. The analyzer 22 output(s) is the input to a decision module 23.

The decision module 23 may determine which, and how many, high-resolution frames should be forwarded to the LPTM 11. The decision module 23 may also determine which of the high-resolution frames to retain in temporary (rolling) storage 24. In this regard the term ‘frames’ may apply to photos, video frames, and streaming audio elements. It is appreciated that the forwarded high-resolution frames may be communicated to the LPTM 11 instead of their respective low-resolution frames or in addition to the respective low-resolution frames.

For example, one type of loss of information may be caused by scene change. There may be several types of scene change. For example, there are types of scene change that are caused by a change of the camera parameters. For example, any type of rotation of the camera such as upward, downward, panning, etc. The camera may also change its field of view (e.g., zoom-in and/or zoom-out). Another type of loss of information may be caused by change in lighting (amount, color, quality, etc.) and the resulting change in camera parameters. Another type of loss of information may be caused by rapid motion of one or more objects in scene, which may be lost due to conversion into low temporal reolution version of the high-resolution content 19. Another type of loss of information may cause the analyzer 22 not to recognize one or more objects in the frame, for example, due to low-resolution.

The goal of the decision module 23 may therefore be to communicate to the LPTM 11 as much as possible low-resolution stream 20 and as little as possible completion of high-resolution stream 19 elements, provided that the loss of imformation is minimal and/or tolerated by the LPTM 11. All such cases of loss of infromation in the low-resolution stream 20 as compared with the high-resolution stream 19 may desire the transmition of one or more high-resolution 19 frames to the LPTM 11.

It is appreciated that if LPTM 11 may determine that one or more of low-resolution stream 20 elements are of insufficient quality, and may then request to receive corresponding high-resolution stream 19. It is appreciated that LPTM 11 may have an identifier for each low-resolution stream 20 element to identify the corresponding high-resolution stream 19 element(s).

Decision modlue 23 may tben forward the selected low-resolution stream 20 as well as the selected high-resolution frames 19 to a compression module 25. It is appreciated that the compression module 25 is optional, for each of high-resolution stream 19, and low-resolution stream 20, independently of each other.

Compression module 25 may use the same compression algorithm to compress both high-resolution 19 and low-resolution stream 20, or may use two different compression algorithms, or may decide not to compress any of the two streams. The output of the compression module 25 may then feed the input of an interleaving module 26. Interleaving module 26 may then arrange streaming elements in a single stream of content data.

Interleaving module 26 may arrange is a single stream streaming elements such as audio elements, video elements, still photos, text, high-resolution elements, and/or low-resolution elements. A method of interleaving streaming elements is further described in US patent No. 10986154, which is incorporated here by reference.

It is appreciated that compression module is optional and/or used acccording to bandwidth limitations. Namely, if bandwidth to the LPTM 11 enables the transmission of high-resolution frames, the decision modlue 23 may forward the low-resolution stream 20 as well as the required high-resolution frames 19 to the interleaving module 26 directly.

Typically, each streaming element carries only one type of medium where a medium contains only one of text (e.g. a prompt), audio, video, and/or photos of a particular resolution. That is to say that, for example, audio and video are carried by different streaminbg elements, and.low-resolution video (or audio) and high-resolution video (or audio) are carried by different streaminbg elements.

It is appreciated that each of the interleaved streaming elements mau carry identification data such as a time-stamp, or an enumerator, so that each such streaming element may be referred to, or pointed, or indexed, directly. It is appreciated that the high-resolution elements stored in storage 24 are also identified in a similar manner.

The single stream of interleaved elements is then provided to the input of a communicator module 27, which output is communicatively coupled to LPTM 11 via any selected type of communication network. Communicator module 28 may use prompts, such as system prompts, to control LPTM 11.

It is appreciated that a goal of resolution optimization system 12 is to provide LPTM 11 with less data than resolution optimization system 12 receives, or even less than the high-resolution content 19. It is therefore appreciated that resolution optimization system 12 may process the commuicated data in real-time. The term real-time in this sense may mean, for example, that the processing by resolution optimization system 12 and the communication of the processed data may take at most the time for communicating the high-resolution content 19 only.

As shown in FIG. 1, communicator module 27 may receive from LPTM 11 a request 29 for any particular high-resolution data element that may be stored in storage 24. Communicator module 27 may then access storage 24 to retrieve the requested data element and provide it to LPTM 11.

In this respect, a user may input some of the data such as user prompts from a client device, and then feed audio and/or video data from a netwok server. Moreover, the client device may include an artificial intelligence (AI) system that may interact with LPTM 11 via resolution optimization system 12.

In this regard, FIG. 1 may represent two AI systems (denoted 11 and 13) that may interact with the mediation of resolution optimization system 12. Hence the process of resolution optimization system 12 (as will be further disclosed below) may be used by both AI systems. Alternatively, each AI system (11 and 13) may use its own resolution optimization system 12. For that matter, each AI system (11 and 13) may be denoted as an input system providing input data.

Prompts 30, such as user prompts and system prompts, may be communicated by resolution optimization system 12 (via communicator module 27) to LPTM 11 to control the operation of LPTM 11. For example, to cause LPTM 11 to issue data request 29 when appropriate.

For example, such system prompt, or rule, may be “If the images received do not contain enough details and/or the images quality is not high enough and/or the images are not focused or not sharp enough please response with <ref>7</ref> and provide the time stamps of the images that need to be replaced by higher quality images <ts>X</ts>”.

Another section of the system prompts may have some examples of how and when to ask for something like data request 29. For example, LPTM 11 may be provided with the knowledge (via a system prompt) that the client has higher quality images for each and every image sent to him in the time span X. For example, “Your task is to analyze the incoming video and find all the dogs, if the video is of poor quality you have the option to report that to the user see key rules on how to achieve that”

Alternatively, resolution optimization system 12 may tune LPTM 11 with a function call that LPTM 11 will return when the image is of poor quality. It is appreciated that LPTM 11 may be originally designed (or trained) to make a particular function call in a particular situation such as insufficient data (e.g., lack of resolution). Alternatiely, LPTM 11 may be set by a prompt (e.g., a system prompt) to make a particular function call in a particular situation such as insufficient data.

It is further appreciated that LPTM 11 may be set to analyse the data insufficiency and make a function call with particular parameters. For example, LPTM 11 may request a better (higher) spatial resolution, or a better temporal resolotion (e.g., more frames for a particular second). For example, LPTM 11 may request a better (higher) spatial resolution for a particular area of a particular frame. For example, LPTM 11 may request a wider field-of-view, for example, to better analyze motion. In any of these situations resolution optimization system 12 may derive the requested data (29) from storage 24 and interleave it (26) in real-time in the ongoing data stream.

It is therefore the combination of conversion to low-resolution (or the use of available low-resolution stream) with the local analysis (actions 22 and 23) and with the optional data request 29 from the LPTM 11 that optimizes the amount of (straming) data that is fed into LPTM 11 by resolution optimization system 12.

Reference is now made to FIG. 2, which is a simplified block diagram of ML analyzer module 22 of feed optimization system 10, according to one exemplary embodiment.

As an option, the illustrations of FIG. 2 may be viewed in the context of the previous Figures. Of course, however, the illustrations of FIG. 2 may be viewed in the context of any desired environment. Further, the aforementioned definitions may equally apply to the description below.

ML analyzer module 22 may start with actions 31 and 32 by receiving high-resolution data 19 and low-resolution data 20. ML analyzer module 22 may then proceed to actions 33 and 34 to determine the content of the high-resolution data 19 and low-resolution data 20. For example, ML analyzer module 22 may provide the high-resolution data 19 and the low-resolution data 20 to a perceived-vision, classifying artificial-intelligence (AI) model 35. AI model 35 may then provide actions 33 and 34, respectively, with high-resolution (HR) recognition data and low-resolution (LR) recognition data.

For example, HR recognition data may include a list of objects the AI model 35 has recognized in each frame of high-resolution data 19, as well as the probability value (confidence level) of the recognition of each such object. Similarly, LR recognition data may include a list of objects the AI model 35 has recognized in each frame of low-resolution data 20, as well as the probability value (confidence level) of the recognition of each such object.

Considering the possibility that the high-resolution data 19 may have a higher frame-rate than the low-resolution data 20, it is appreciated that action 33, determining the content of high-resolution data 19, may send to AI model 35 only some of the frames of high-resolution data 19. However, for example, at least two frames for each frame of low-resolution data 20, to determine, for example, motion effects, or the loss of a motion effect.

It is appreciated that a small AI model 35 may be implemented in input device 13, while a large (more sophisticated and more accurate) AI model 35 may be implemented in the cloud.

Actions 33 and 34 may then provide high-resolution data 19 and low-resolution data 20 as well as the corresponding HR recognition data 36 and LR recognition data 37, to decision module 23.

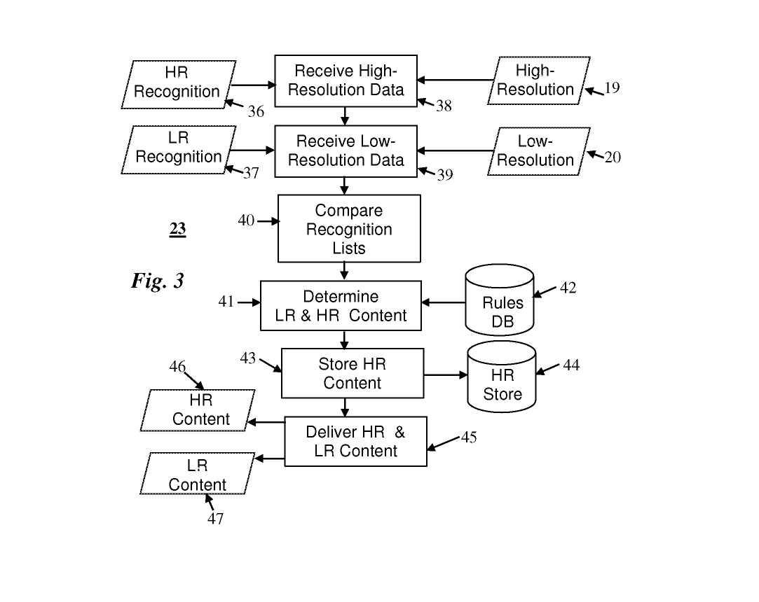

Reference is now made to FIG. 3, which is a simplified block diagram of decision module 23 of feed optimization system 10, according to one exemplary embodiment.

As an option, the illustrations of FIG. 3 may be viewed in the context of the previous Figures. Of course, however, the illustrations of FIG. 2 may be viewed in the context of any desired environment. Further, the aforementioned definitions may equally apply to the description below.

Decision module 23 may start with actions 38 and 39 by receiving high-resolution data 19 and low-resolution data 20 as well as their corresponding HR recognition data 36 and LR recognition data 37. Decision module 23 may then proceed to action 40 to compare the LR recognition data 37 with the HR recognition data 36, and to action 41 to determine if to further provide the low-resolution data 20 or the high-resolution data 19.

Action 41 may determine which of the LR and the HR content to forward to the compression module (element 25 of FIG. 1) according to rules. For example, such rules may be stored in rules database 42. Here are some examples of such rules that may result in further communicating an element (such as a frame) of high-resolution data 19 instead of a corresponding element of the low-resolution data 20.

A. The HR recognition data of a particular frame includes an object with a score (probability value, confidence level) higher than a predetermined threshold, and the LR recognition data of the corresponding frame does not include this object, then forward the high-resolution element (frame), else forward low-resolution element (frame).

B. The HR recognition data of a particular frame includes an object with a probability value (confidence level) higher than a predetermined threshold, and the LR recognition data of the corresponding frame includes the same object with a probability value (confidence level) less than a predetermined threshold, then forward the high-resolution element (frame), else forward the low-resolution element (frame).

C. The ratio between the probability values (confidence levels) of the LR object and the HR object (for corresponding frames) is lower than a predetermined threshold, then forward the high-resolution element (frame), else forward the low-resolution element (frame).

D. In a sequence of three consecutive LR frames only the middle frame includes a particular object, and In a time-corresponding sequence of three consecutive HR frames at least two frames include the same particular object, then forward the high-resolution elements (frame), else forward the low-resolution element (frame).

The exemplary rules above all use a single threshold per rule. However, two or more thresholds are contemplated. For example, a second threshold may determine that the high-resolution data 19 should be send to resolution converter 21 to be converted to mid-resolution data.

Decision module 23 may then proceed to action 43 to store in storage 44 high-resolution data that is not being forwarded, and to action 45 to provide to the compression module 25 (or to the interleaving module 26) the high-resolution content 46 and the low-resolution content 47 as determined by action 41.

It is appreciated that storage 48 may be too small to store all the high-resolution data that is not being forwarded. Therefore storage 49 may be a rolling storage in the sense that it stores a predetermined amount of data which is last to be forwarded to storage 50. Additionally, or alternatively, decision module 23 may provide storage 51 with high resolution elements that fit into a margin above and/or below any of the thresholds of rules such as the abovementioned rules.

As described above with reference to FIG. 1, LPTM 11 may communicate one or more data requests 29 to receive one or more high-resolution elements from storage 24. In such case ML analyzer module 22, and/or decision module 23 may be notified by storage 24 regarding the data requests 29, the subject low-resolution elements, and the required high-resolution elements. For example, ML analyzer module 22 may use such input to re-train ML model 35. For example, decision module 23 may use such input to tune (callibrate) one or more rules, for example by modifying one or more thresholds as well as their associated margins.

It is appreciated that certain features, which are, for clarity, described in the context of separate embodiments, may also be provided in combination with a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent, or patent application was specifically and individually indicated to be incorporated herein by reference. In addition, citation, or identification of any reference in this application shall not be construed as an admission that such reference is available as prior art.

What is claimed is:

1. A computer-implemented method for optimizing the feed of streaming data to a large Pre-Trained Model (LPTM), the method comprising:
obtaining a first streaming data from a high-resolution input device, the first streaming data is of high-resolution;
obtaining a second streaming data being at least one of:
sourced from a low-resolution input device; and
a conversion of the first streaming data into low-resolution;
analyzing at least one of the first streaming data and the second streaming data to determine loss of critical information in the second streaming data; and
providing the Large Pre-trained Model, at least part of the second streaming data augmented with interleaved data from the first streaming data, to avoid the loss of the critical information.

2. The computer-implemented method according to claim 1, additionally comprising:
converting the first streaming data into the second streaming data by reducing at least one of: spatial resolution, temporal resolution and color resolution.

3. The computer-implemented method according to claim 1, additionally comprising:
wherein at least one of the actions of:
converting the first streaming data into low-resolution; and
analyzing at least one of the first streaming data and the second streaming data to determine loss of critical information in the second streaming data;
is performed in real-time.

4. The computer-implemented method according to claim 1, additionally comprising at least one of:
analyzing, by a machine-learning module operative to continuously analyze at least one of the first streaming data and the second streaming data, in real-time, based on predefined goals;
determining, by a decision module operative to determine at least one optimal point to interleave data elements of the first streaming data in the second streaming data; and.
storing, locally, high-resolution data elements of the first streaming data.

5. The computer-implemented method according to claim 4, additionally comprising at least one of:
evaluating, wherein the first streaming data is video, and the machine-learning module is operative to evaluate the video to identify frames of interest based on at least one of: motion detection, object recognition, scene change, camera motion, and change of field of view.

6. A computer-implemented method for optimizing the feed of streaming data to a large Pre-Trained Model (LPTM), the method comprising:
obtaining a first streaming data from a high-resolution input device, the first streaming data is of high-resolution;
obtaining a second streaming data being at least one of:
sourced from a low-resolution input device; and
a conversion of the first streaming data into low-resolution;
storing at least part of the first streaming data;
communicating at least part of the second streaming data to the LPTM;
receiving from the LPTM a request for at least part of the first streaming data; and
communicating the requested at least part of the first streaming data to the LPTM.

7. The computer-implemented method according to claim 6, additionally comprising:
wherein the first streaming data and the second streaming data comprise data elements;
wherein each data element is identified by an identifier; and
wherein the request for at least part of the first streaming data comprises at least one identifier.
